(19) United States
(12) Patent Application Publication
(10) Pub. No.: US 2026/0311431 A1
(43) Pub. Date: Oct. 8, 2026

(54) Geospatial Data Processing System

(71) Applicant: SynPlanet Holding Corporation, Newark, DE (US)

(72) Inventor: Andrey Kirsanov, Hamilton South (AU)

(21) Appl. No.: 19/637,345

(22) Filed: Apr. 2, 2026

Related U.S. Application Data
(60) Provisional application No. 63/782,522, filed on Apr. 2, 2025.

(51) Int. Cl. G06T 17/20; G06F 16/11; G06F 16/29; G06T 15/04; G06T 17/05

(52) U.S. Cl. CPC G06T 17/20; G06F 16/116; G06F 16/29; G06T 15/04; G06T 17/05; G06T 2210/32

(57) ABSTRACT

Techniques are disclosed for performing geospatial data processing to generate terrain data suitable for virtual tessellation based on a quadtree and a corresponding folder hierarchy. For this purpose, a tile generation module is used to generate geometry files representing the tiles of the terrain of a georeferenced synthetic environment being generated. A texture generation module is also employed that generates texture files representing the textures of the tiles being generated. A texture coordinate mapping module is further employed that generates texture coordinate mappings that map the tiles to their respective textures. The geometry files, texture files and texture coordinate mapping files are stored in respective folders of the folder hierarchy, each such folder corresponding to a tile being generated. 3D model files corresponding to respective tiles are then generated and supplied to a rendering engine to render the synthetic environment employing virtual tessellation.

### RELATED APPLICATIONS

This application claims priority from U.S. Provisional Patent Application No. 63/782,522 filed on Apr. 2, 2025, which is incorporated by reference herein for all purposes in its entirety.

### FIELD OF THE INVENTION

This invention relates generally to Geographic Information Systems (GIS) and more specifically to geospatial data processing systems that support virtual tessellation.

### BACKGROUND ART

Geographic Information Systems (GIS) are used for capturing, analyzing, and visualizing spatial data to understand relationships, patterns, and trends in the real world. These systems integrate multiple types of maps, satellite imagery, and tabular information and enable users to overlay, analyze, and derive geographic insights about the data. GIS has applications in various fields, including urban planning, environmental management, public health, and disaster response. By combining spatial data with analytical capabilities, GIS empowers users to address complex problems, such as urban planning, optimizing transportation networks, monitoring deforestation, planning emergency evacuations, among others.

Useful applications of GIS systems involve georeferenced data that aligns spatial data to a known coordinate system, for providing accurate representations of locations on Earth. Georeferencing involves associating datasets like scanned maps, aerial photographs, or field observations with geographic coordinates, enabling integration with other spatial layers. Georeferenced data allows users to compare and contrast datasets from different sources, conduct precise measurements, create meaningful visualizations and perform spatial and geographic analysis.

Various GIS systems also utilize terrain rendering. Terrain rendering is the process of visually representing the surface of the Earth or a simulated environment in a 3D space for applications such as GIS, video games, virtual environments, or simulation. Most common terrain rendering is the depiction of the surface of the Earth. It is used in various applications to give an observer a frame of reference. It is also often used in combination with rendering of non-terrain objects, such as trees, buildings, rivers, etc. A typical terrain rendering system includes a terrain database, a central processing unit (CPU), a dedicated graphics processing unit (GPU), and a display.

Geospatial data processing refers to processing source data comprising raster data, elevation data, and vector-defined shapes to generate tiles represented by meshes, associated textures, and surface type classifications for a georeferenced environment. In certain implementations, the generated mesh data may be provided to a virtualized geometry rendering system, such as the Nanite® platform of Unreal Engine®, which employs an internal mesh representation and rendering techniques to achieve pixel-scale detail and high object counts. Such systems further f support compressed data formats, fine-grained streaming, and automatic level of detail, which collectively correspond to virtual tessellation. By way of 41 comparison, FIG. 1 illustrates a conventional tessellation pipeline in which a smooth sphere is rendered from a coarse cubic vertex set using a Catmull-Clark subdivision method of the prior art.

In as far as geospatial data processing and virtual tessellation are concerned, there is plenty of prior art. U.S. Patent Publication No. 2011/0316854 A1 to Vandrovec describes a process for optimizing a tile mesh for a surface in a level-of-detail hierarchy. The includes obtaining a a plurality of elevation values for an elevation grid of the surface and down-sampling the elevation grid to a resolution based on a minimum edge size for triangles of the tile mesh as determined by a level-of-detail parameter. The process also includes encoding the elevation grid into a linearized quadtree of virtual nodes and iteratively optimizing the quadtree according to an adaptive sampling pattern based on one or more prioritized split tests. Their process further includes converting the optimized linearized quadtree into a tile mesh.

U.S. Patent Publication No. 2013/0013094 Al to Parks et al. discloses methods for establishing a location-based leaderboard by a computer game system. The world is partitioned into a set of regions and sub-regions by the computer game system using a hierarchical spatial data structure, wherein the regions and sub-regions are arranged according to a hierarchy. Each sub-region is encompassed by a higher-level sub-region or region, and two or more highest-level sub-regions are encompassed by a region. A location of a user of the computer game system along with one or more statistics associated with the user is assigned to a smallest sub-region created by the hierarchical spatial data structure. A rank of the user is then be determined within a region or sub-region encompassing the smallest sub-region to which the user's location was assigned, wherein the rank is determined using the one or more statistics associated with the user. One or more users are then be notified of the rank.

The article entitled “Multi-resolution terrain rendering with GPU Tessellation” dated 2015 by argues that GPU tessellation is very efficient and is reshaping the terrain rendering paradigm. The authors present a purportedly novel terrain rendering algorithm based on GPU tessellation. The planar domain of the terrain is partitioned into a set of tiles, and a coarse-grained quadtree is constructed for each tile using a screen-space error metric. Then, each node of the quadtree is input to the GPU pipeline together with its own tessellation factors. The nodes are tessellated and the vertices of the tessellated mesh are displaced by filtering the displacement maps. The multi-resolution scheme is designed to optimize the use of GPU tessellation. Further, the algorithm accepts not only height maps but also geometry images, which displace more vertices toward the higher-curvature feature parts of the terrain surface such that the surface detail can be well reconstructed with a small number of vertices. The efficiency of the proposed method is proven through experiments on large terrain models. When the screen-space error threshold is set to a pixel, a terrain surface tessellated into 8.5M triangles is rendered at 110 fps on commodity PCs.

Despite the availability of prior art, what is needed is a geospatial data processing system that enables virtual tessellation of terrain data and generates a hierarchical, tile-based three-dimensional (3D) representation of a geographic environment. Such a system, absent from the prevailing art, would be based on a quadtree architecture and associated folder hierarchy that would significantly reduce the number of levels required for terrain generation. The present technology addresses these unmet needs of the industry.

### OBJECTS OF THE INVENTION

In view of the shortcomings of the prior art, it is an object of the invention to perform geospatial data processing and in particular enable virtual tessellation for rendering terrains.

It is also an object of the invention to perform geospatial data processing by employing a quadtree of nodes that is correspondent to a folder hierarchy for storing geometric, texture and mapping files required to render a georeferenced synthetic environment. It is further an object of the invention to use a tile generation module for generating geometry files of the tiles being generated for rendering the georeferenced synthetic environment.

It is also object of the invention to use a texture generation module to generate texture for the tiles being generated.

It is also an object of the invention to use a texture coordinate mapping module to generate UV mappings that map tiles to their respective textures.

It is further an object of the invention to generate three-dimensional (3D) model files required to render the georeferenced environment.

If is also an object of the invention to package the geometry, texture and mapping files into a spatial database.

Still other objects and advantages of the invention will become apparent upon reading the summary and the detailed description in conjunction with the drawing figures.

### SUMMARY OF THE INVENTION

The objects and advantages of the invention are achieved by apparatus and methods for performing geospatial data processing based on the instant principles. For this purpose, a quadtree data structure is first created in random access memory (RAM). Each internal quadtree node has four nodes as children while the leaf nodes have no children. In correspondence with the quadtree, a folder hierarchy or a folder structure is also created. The folder hierarchy has folders corresponding to each node of the quadtree. In other words, the top-level folder has four subfolders or simply folders, each of which also has four folders and so on until the folders corresponding to leaf nodes that have no further subfolders or folders.

The depth of the quadtree and the number of folders in the folder hierarchy depend on the source resolution, which refers to the resolution of source raster data stored in a source database. The source database is preferably a file persisted in an on-premise or a cloud database. The depth also depends on the level of data rendering and the scope selected by a user via an input module. The input module is preferably a georeferenced synthetic environment generation system. The folder hierarchy is logically stored in a destination database. The destination database is preferably a file that is persisted preferably in the above on-premise or a cloud database.

Instant geospatial data processing system also includes a tile generation module that is responsible for generating the geometry files of the tiles being rendered by the system. It does so by consulting elevation data and surface vector data of the tiles. The geometry files, containing the mesh data of the tiles, along with elevation and type data are consequently stored in respective folders or directories in the folder hierarchy.

There is also a texture generation module, whose job is to generate textures for the tiles being generated. Texture generation module accomplishes its objective by converting source raster data to a first image file format, preferably Geographic Tagged Image File Format (GeoTIFF). In doing so, it also slices the source raster data into smaller pieces and scales it, thus obtaining prepared raster data as respective prepared raster data files for the respective tiles being generated.

Texture generation module further creates respective intermediate image files or simply respective intermediate files, that are preferably in Joint Photographic Experts Group (JPEG or JPG) format. Each such intermediate JPG file is respective to a tile being generated and is stored in the corresponding folder in the folder hierarchy. Each intermediate file is scaled from a maximum-level intermediate file, which is the file with the highest resolution along the texture path of the intermediate file.

Texture generation module then incorporates the prepared raster data from respective prepared raster data files, into respective intermediate files. It does so by incorporating or pasting raster information from prepared raster data files, preferably in GeoTIFF format, into only the intersecting portions of the intermediate files, preferably in JPG format. Texture generation module thus generates the respective texture files of the tiles based on the above respective intermediate files. The texture files thus generated are preferably in DirectDraw Surface (DDS) file format.

There is further a texture coordinate mapping module that generates texture coordinate or UV mappings that maps tiles to their respective textures obtained above. The texture coordinate or UV mapping of each tile is stored as a texture coordinate/UV mapping file in its respective folder in the folder hierarchy, along with its other visualization files or assets including the geometry file (mesh), the texture file and the intermediate file. Texture coordinate mapping module then generates 3D model files for the tiles based on their respective geometry files, respective texture files and respective texture coordinate mapping files. There is a 3D model file for each tile and is stored in its respective folder along with its other visualization files discussed above, including the geometry file, the texture file, the intermediate file and the texture coordinate mapping file. Preferably, the 3D model files are in Filmbox (FBX) format.

The self-contained 3D model files for respective tiles obtained above are now ready for rendering. For this purpose, a rendering engine is employed. The rendering engine takes as input the 3D model files and renders or generates a georeferenced synthetic environment that is presented on a computer display. The environment thus generated is sliced or partitioned into tiles based on the above-described design. The present invention thus performs geospatial data processing and more specifically virtual tessellation processing. In other words, the rendering engine renders the tile-based terrain with a virtualized geometry that supports virtual tessellation. In one embodiment, the rendering engine is the Nanite® platform of Unreal Engine® from Epic Game®. In the same or a related embodiment while selecting the above-mentioned source resolution, priority is preferably given to source raster data over elevation data.

A preferred embodiment further includes a packaging module that produces a binarized spatial database file packaging the geometry files, texture files and UV mapping files stored in respective folders in the folder hierarchy that is logically stored in the destination database. Spatial database or .sdb file is also preferably stored in in the on-premise or cloud database discussed above.

The systems and apparatus of the present technology include a geospatial data processing system executing computer-readable instructions stored in a non-transitory storage medium and at least one microprocessor coupled to said non-transitory storage medium for executing said computer-readable instructions, said computer-readable instructions causing said at least one microprocessor to: (a) create a quadtree in said non-transitory storage medium, said quadtree comprising a plurality of nodes representing respective tiles of a terrain; (b) based on a scope and a level of data rendering selected by a user and further based on a source resolution, generate and store a folder hierarchy in a destination database, said folder hierarchy comprising a plurality of folders corresponding to said plurality of nodes of said quadtree; (c) generate by a tile generation module, respective geometry files of said respective tiles in said plurality of folders based on elevation data and surface vector data of said respective tiles; (d) deploy a texture generation module to convert source raster data to a first image file format and to slice it and scale it to obtain prepared raster data; (e) create by said texture generation module, respective intermediate files in a second image file format in said plurality of folders stored in said destination database, wherein each of said respective intermediate files resides along its texture path in said folder hierarchy, and wherein said each of said respective intermediate files is scaled from a maximum-level intermediate file amongst raid respective intermediate files, said maximum-level intermediate file residing at the maximum level of said texture path; (f) incorporate by said texture generation module, said prepared raster data into said respective intermediate files; (g) deploy said texture generation module to generate respective texture files for said respective tiles based on said respective intermediate files and to store said respective texture files in said plurality of folders; (h) deploy a texture coordinate mapping module to compute respective texture coordinate mappings for mapping said respective tiles to said respective texture files, and to store said respective texture coordinate mappings as respective texture coordinate mapping files in said plurality of folders stored in said destination database; (i) generate by said texture coordinate mapping module, respective three-dimensional (3D) model files based on said respective geometry files, said respective texture files and said respective texture coordinate mapping files; and (j) use a rendering engine to render based on said respective 3D model files, a synthetic environment sliced into said respective tiles.

The methods of the present technology include a computer-implemented method comprising the steps of: (a) creating a quadtree in a non-transitory storage medium of a computer system, said quadtree comprising a plurality of nodes representing respective tiles of a terrain; (b) based on a scope and a level of data rendering selected by a user and further based on a source resolution, generating and storing a folder hierarchy in a destination database, said folder hierarchy comprising a plurality of folders corresponding to said plurality of nodes of said quadtree; (c) generating respective geometry files of said respective tiles in said plurality of folders based on elevation data and surface vector data of said respective tiles; (d) converting source raster data to a first image file format and slicing and scaling it to obtain prepared raster data; (e) creating respective intermediate files in a second image file format in said plurality of folders stored in said destination database, wherein each of said respective intermediate files resides along its texture path in said folder hierarchy, and wherein said each of said respective intermediate files is scaled from a maximum-level intermediate file amongst raid respective intermediate files, said maximum-level intermediate file residing at the maximum level of said texture path; (f) incorporating said prepared raster data into said respective intermediate files; (g) generating respective texture files for said respective tiles based on said respective intermediate files and storing said respective texture files in said plurality of folders; (h) computing respective texture coordinate mappings for mapping said respective tiles to said respective texture files, and storing said respective texture coordinate mappings as respective texture coordinate mapping files in said plurality of folders stored in said destination database; (i) generating respective three-dimensional (3D) model files based on said respective geometry files, said respective texture files and said respective texture coordinate mapping files; and (j) rendering a synthetic environment sliced into said respective tiles based on said respective 3D model files.

Clearly, the systems and methods of the invention find many advantageous embodiments. The details of the invention, including its preferred embodiments, are presented in the below detailed description with reference to the appended drawing figures.

### BRIEF DESCRIPTION OF THE DRAWING FIGURES

FIG. 1 shows a simple tessellation pipeline rendering a smooth sphere from a crude cubic vertex set using a subdivision method of the prior art.

FIG. 2 illustrates the design and architecture of a geospatial data processing system based on the instant principles.

FIG. 3 illustrates a flowchart or a flow diagram showing the operational steps of a preferred embodiment of the geospatial data processing system of the present design.

FIG. 4A schematically depicts an internal node of an instant quadtree.

FIG. 4B illustrate an exemplary quadtree in which its node 4 has 4 children, of which child node 1 also has four children.

FIG. 4C-D illustrate an exemplary quadtree and the corresponding folder structure based on the instant techniques.

FIG. 4E illustrates an exemplary quadtree for elucidating the process of generating neighboring tiles in the present technology.

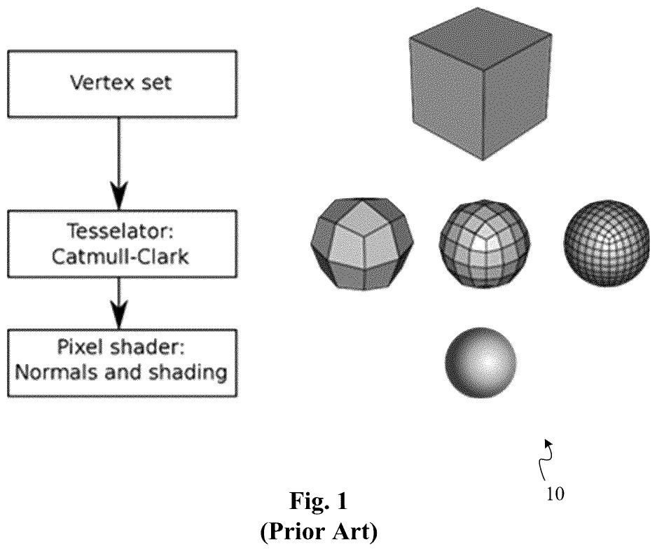

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. The figures depict embodiments of the present invention for purposes of illustration only. One skilled in the art will readily recognize from the following description that alternative embodiments of the structures and methods illustrated herein may be employed without departing from the principles of the invention described herein.

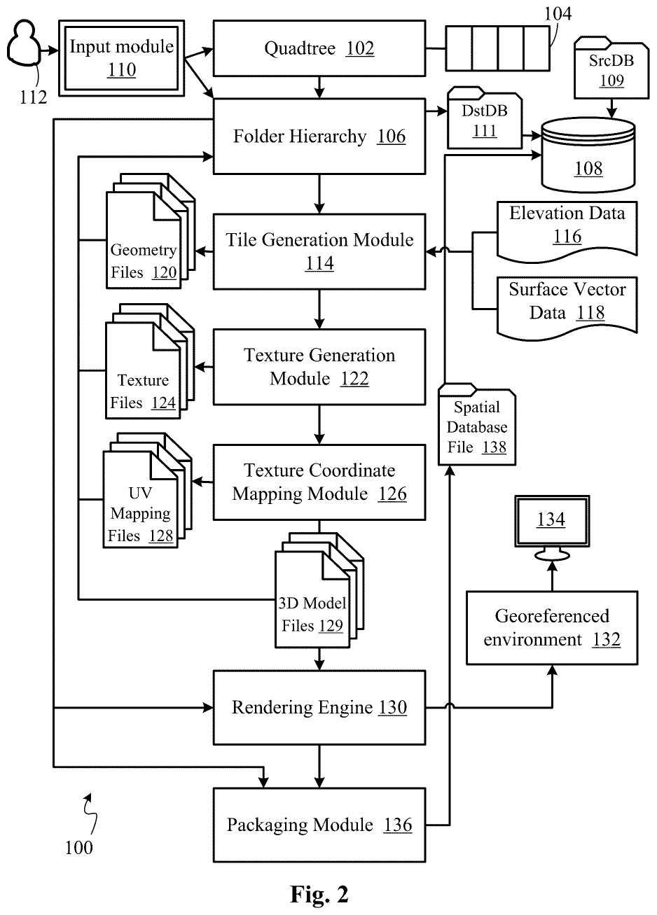

The systems and methods of the present invention will be best understood by first reviewing a geospatial data processing system 100 as depicted in FIG. 2. FIG. 2 shows that geospatial data processing system or platform 100 has a quadtree 102 and a corresponding folder hierarchy 106. Quadtree 102 is a data structure that is preferably created by system 100 in random access memory (RAM) 104 as shown. The reason for doing so is the ability of the various modules of system 100 to traverse quadtree 102 and corresponding folder hierarchy 106 in an efficient manner.

Folder hierarchy 106 is preferably created by system 100 in a filesystem on an appropriate storage network/subsystem/device. Such a filesystem and a storage device are not explicitly shown in FIG. 2 in order to avoid clutter. However, database 108 is explicitly shown that is used to persist quadtree 102 in a preferred embodiment. Furthermore, folder hierarchy 106 is logically stored in a destination database file or files or simply a destination database DstDB 111 that is also persisted in database 108 as shown in the embodiment of FIG. 2. Depending on the embodiment, database 108 may be a relational or any other appropriate database known in the art. Such a database may be on-premise, or in the cloud, including a cloud database such as Amazon AWS™ S3. Alternatively, database 108 may even be just a filesystem in which DstDB file or simply DstDB 111 is stored.

As noted, folder hierarchy 106 is logically stored in DstDB 111 rather than as physical directories. What this means is that folder hierarchy 106 is converted into a logical or serialized representation that is then stored in the database. This representation preferably encodes the hierarchy using node identifiers, parent-child relationships, and level indices corresponding to quadtree 102. In this manner, the hierarchical organization is preserved and can be reconstructed or traversed without requiring a physical directory structure.

There is also a tile generation module 114 that is responsible for generating the individual tiles of the terrain generated by geospatial data processing system 100 as will be explained herein. Tile generation module 112 generates geometry files 120 corresponding to the various tiles by/into which the terrain being rendered is being sliced. Geometry files 120 respectively store three-dimensional (3D) mesh data of the tiles including vertices, faces, and associated spatial indices. Explained further, the terrain is sliced or partitioned into or by the individual tiles that are represented as meshes and the 3D data for the mesh of each such tile is represented by a respective geometry file 120.

The number of such tiles and the area on the ground or Earth that such a tile represents depends on the resolution of the source data i.e. source resolution. It further depends on the level of geospatial data generation/rendering or simply the level selected by user 112 via input module 110. The number of such tiles and the area represented by them also depends on the scope of geospatial data generation or simply the scope selected by user 112 via input module 110. In the preferred embodiment, input module 110 is a georeferenced synthetic environment generation system. In some embodiments, such a georeferenced synthetic environment generation system may be referred to as SynTerra. The source data is stored in a source database file simply SrcDB 109 also preferably stored in database 108.

There is also a texture generation module 122 that is responsible for generating respective texture files 124 for respective tiles generated by tile generation module 114 as respective geometry files 120. In other words, there is a one-to-one correspondence between texture files 124, geometry files 120 and the tiles being generated. Further, these files are stored in respective folders or directories of folder or directory hierarchy 106.

The textures for the tiles contained in texture files 124 are applied to the tiles, and more specifically their geometry files 120, via a texture coordinate or UV mapping. This task is accomplished by texture coordinate mapping module 126. There is one texture coordinate/UV mapping for each of texture files 124 and it maps the tile to its texture. Each such UV mapping is stored in a corresponding texture coordinate or UV mapping file 128. As a result of the above mapping, texture coordinate mapping module 126 produces 3D model files 129 containing the mesh/geometry of each tile with texture/UV coordinates embedded.

A rendering engine 130 takes as input 3D model files 130 and renders generates a georeferenced environment 132 that is presented on a computer display or screen 134 as shown. Such an environment is preferably a georeferenced synthetic environment. There is also a packaging module 136 that produces a binarized spatial database file 138 packaging or containing geometry files 120, texture files 124 and UV mapping files 128 stored in respective folders in folder hierarchy 106 logically stored in DstDB 111. Spatial database or file 138 is also preferably stored in database 108 as shown.

### Detailed Design and Operation

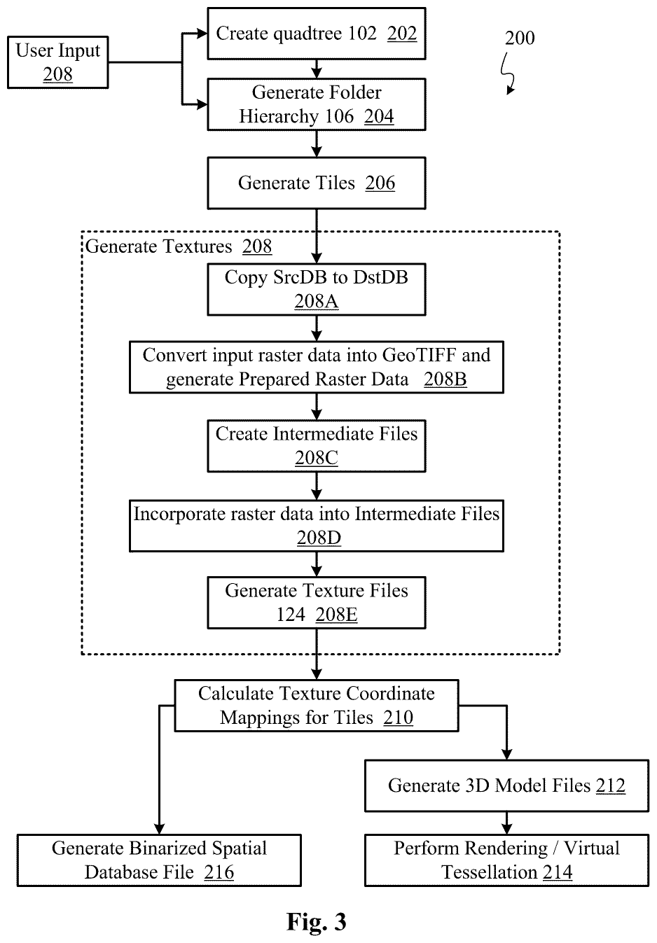

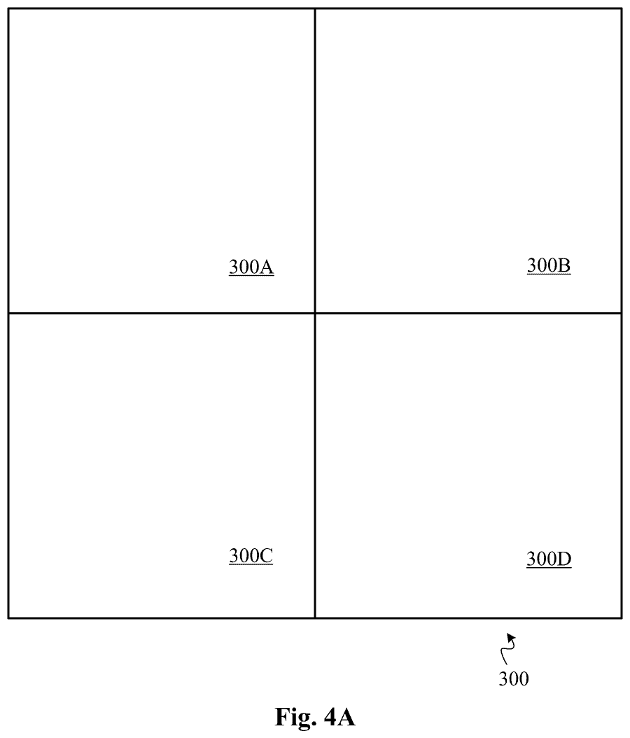

Let us now further study the detailed design and operation of geospatial data processing system 100 of FIG. 2. For this purpose, let us take advantage of the flowchart or flow diagram 200 of FIG. 3 in conjunction with other drawing figures as discussed herein.

### Folder Hierarchy Generation

As a first step, geospatial data processing system 100 of FIG. 2 creates quadtree 102 as shown by step/box/block 202 of flowchart 200. Most preferably, quadtree 102 is created in RAM/memory 104 for reasons of efficiency. However, alternative implementations creating quadtree 102 directly in a persistent storage are conceivable.

The operation of creating quadtree 102 may be performed by the main code of system 100 or by a dedicated module. In any case, quadtree 102 is a tree-based data structure in which each internal node has exactly four children while the leaf nodes have no children. Such a data structure recursively partitions a two-dimensional space into axis-aligned quadrants or quarter tiles. Each node represents a spatial region and may store data or references corresponding to that region, with leaf nodes representing the finest subdivision.

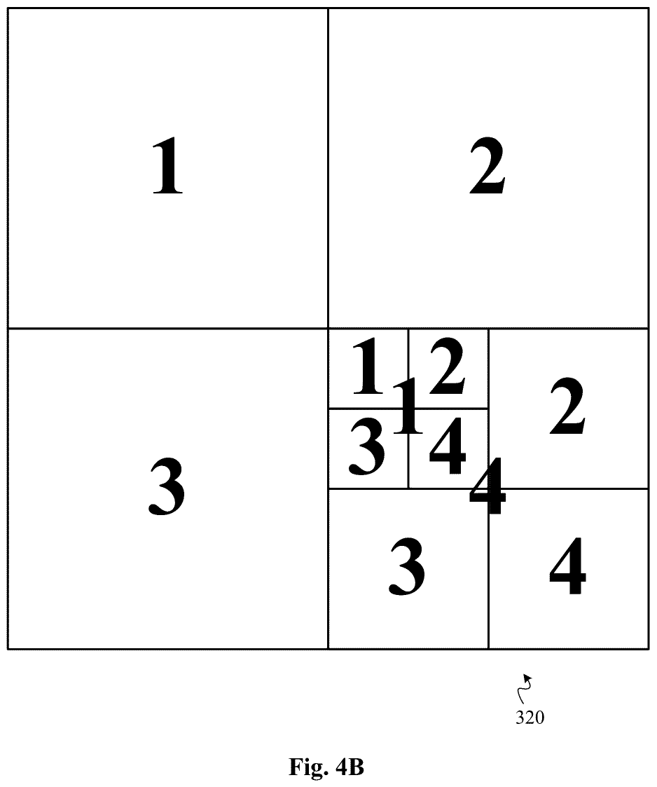

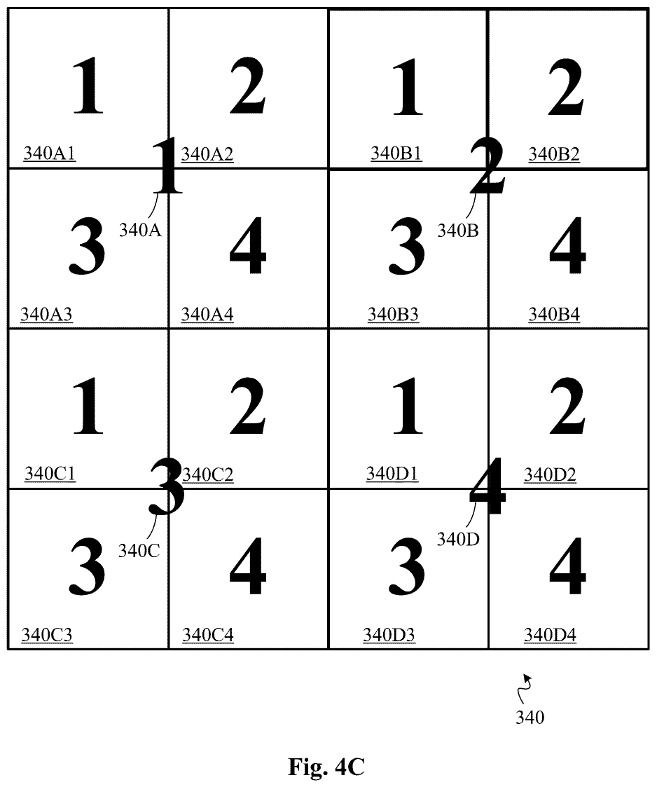

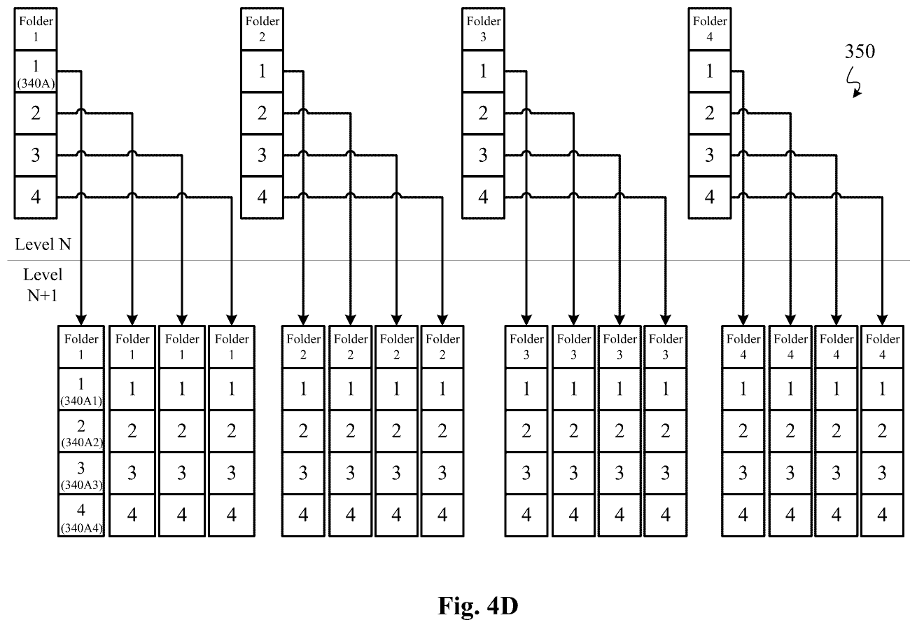

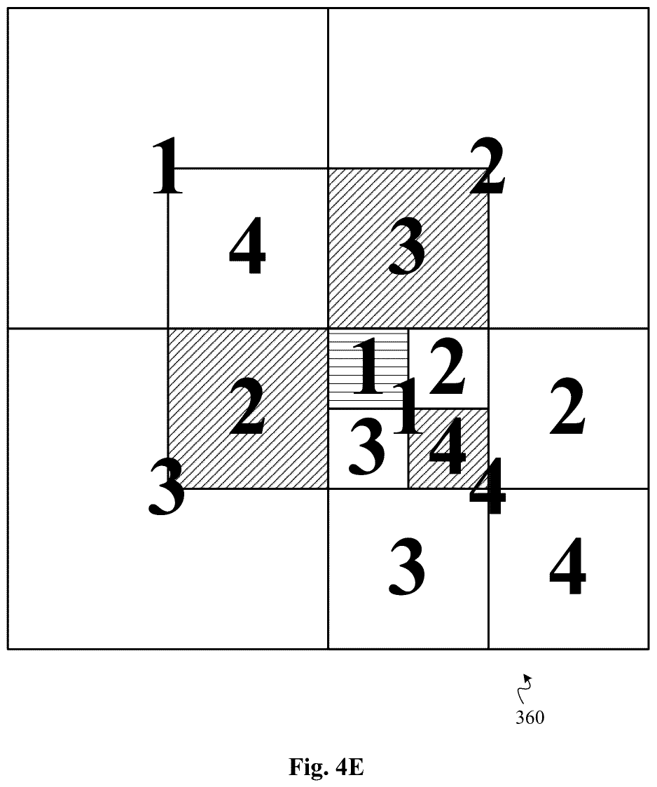

FIG. 4A shows an internal node 300 of such a quadtree 102 of FIG. 2. Node 300 has four quadrants or quarter tiles named 1, 2, 3 and 4 representing four children nodes marked by reference numerals 300A, 300B, 300C and 300D respectively as shown. FIG. 4B shows a quadtree 320 in which its node 4 has 4 children, of which child node 1 has four children as shown. The four child nodes in quadtree 320 are respectively named 1, 2, 3 and 4 as shown. Each node of quadtree 102 represents a tile of the terrain being generated by geospatial data processing system 100 of FIG. 2. Each node contains a name e.g. 1, 2, 3 or 4 which is preferably of type uint64 i.e. a 64-bit unsigned integer. It also contains a link to the parent node, and four links to its four respective children. The nodes are all preferably stored in RAM 104 per above.

Referring again to flowchart 200, system 100 of FIG. 2 next creates a folder hierarchy or folder structure 106 correspondent to quadtree 102 of FIG. 2. This is shown by step. What this means is that for each internal node of the quadtree, there is a corresponding folder in folder hierarchy 106 containing four subfolders or simply folders. Thus, for an exemplary quadtree 340 of the present design shown in FIG. 4C, the corresponding folder structure 350 is shown in FIG. 4D. Quadtree 340 has 4 internal nodes 1, 2, 3, 4 marked by reference numerals 340A, 340B, 340C and 340D respectively. Furthermore, each of nodes 340A-D has four leaf nodes. Thus, node 340A has four leaf nodes 1, 2, 3, 4 marked by reference numerals 340A1, 340A2, 340A3 and 340A4 respectively, and so on.

The respective or corresponding/correspondent folder hierarchy 350 of FIG. 4D has four folders Folder 1, Folder 2, Folder 3 and Folder 4 respective to nodes 340A, 340B, 340C and 340D of quadtree 240. These folders are at level N as shown. Each folder contains respective visualization files or assets generated by system 100 for respective tiles of the terrain being rendered by system 100. Such visualization files include respective geometry files 120, respective terrain files 124, respective texture coordinate mapping files 128 and respective 3D model files 129 for the corresponding tiles. Per above, folder hierarchy 106 is logically stored in DstDB 111 stored in database 108.

As depicted in FIG. 4D, Folder 1 at Level N has its corresponding node 340A shown in parentheses. Each of Folders 1-4 also has four folders or subfolders. Folder 1 respective to node 340A has four folders 1, 2, 3, 4 respective to leaf nodes 340A1, 340A2, 340A3 and 340A4 shown in parentheses in FIG. 4D. These folders are at level N+1. Folders 1, 2, 3 and 4 at level N+1 have no further folders/subfolders because they are respective to the leaf nodes of quadtree 340.

The number of levels in quadtree 102 and folder hierarchy 106 depends on the resolution of original rasterized source data, as well as the level of data rendering chosen by user 112 via input module 110. When rasterized source data and the elevation grid for the terrain are available, priority is given to the rasterized source data i. e. the resolution of the rasterized source data is selected as the resolution of the source data. The resolution of source data thus selected is also referred to as source resolution.

The higher the source resolution, the more the number of levels in quadtree 102 and hierarchy/structure 106. Rasterized source data is preferably stored in a source database i.e. SrcDB file or simply SrcDB 109 shown in FIG. 2. Level 1 or the topmost level represents the coarsest resolution of the corresponding tile. With each subsequent lower level, the resolution increases until the finest resolution is reached at the respective tiles at the lowest levels of the quadtree and folder structure. Evidently, the lowest level also corresponds to the leaf nodes of quadtree 102.

The number of nodes and folders in quadtree 102 and folder hierarchy 106 respectively also depends on the scope or the area to be included in geospatial data processing. The larger the scope, the more the breadth i.e. the number of nodes and the corresponding folders at a given level. Per above, the higher the resolution and the level, the more the depth i.e. the number of levels of the nodes and the corresponding folders.

In the preferred embodiment, system 100 creates folders for the entire Earth. The folders are created from low resolution or lower level to high resolution or higher level. For example, folders are created form Level 1 to Level 10. The folder numbers or names 1, 2, 3, 4 of the above examples of FIG. 4 determine the number of the quarter tile (the generated elevation grid), per FIG. 4A. Each tile is stored in its folder. More specifically, the visualization files 120, 124, 128 and 129 of the tiles are stored in their respective folders. Thus, for a given tile e.g. tile respective to leaf node 1 of FIG. 4B, the highest resolution files will be in the folder with folder path 4,1,1 while at next lower resolution, the visualization files/assets will reside in folder 4,1 representing the next larger but coarser tile. Folder with folder path 4 in the lower-right quarter tile in FIG. 4B will contain the visualization files of the coarsest tile in folder path 4,1,1.

As a further example, if the source resolution of source data (SD) in SrcDB 109 is 500 meters/pixel, this corresponds to 10 levels of folder nesting, e.g. 2/3/1/1/1/1/4/1/1/1. Level 1 corresponds to whole Earth, and Level 10 represents the highest resolution i.e. 500 m/pixel. In order to create folder hierarchy 106, system 100 generates levels form the lower level i.e. Level 1 to the highest level i.e. Level 10. So, that means that four folders corresponding to the root node of quadtree 102 are created at the top level first, then four folders are created within each folder at the next higher level, and so on.

### Tile Generation

Next step 206 of flowchart 200 is executed by system 100 of FIG. 2 in order to generate the tiles of the terrain being rendered. We also refer the tiles to slice the terrain or that the terrain is being sliced into tiles. This task is accomplished by tile generation module 114 of FIG. 2 per above. As noted above, tile generation module 114 does this by generating respective geometry files 120 for the tiles. The geometry of each such tile is represented by a geometry file 120. Each such file is generated and placed by system 100 in the folder respective to the tile whose geometry it represents.

For each tile being generated, its neighboring tiles are identified and generated. The process is started at the highest level i.e. Level 10 in the above example, and continued upwards until reaching Level 1. In other words, for each level N, at level N−1 from high to low (from Level 10to Level 1) neighboring folders are created at each new low N−M level, where M∈[0, N]. This process eliminates breaks in the terrain surface when drawing adjacent levels.

Continuing with the above example of FIG. 4B i.e. for folder path . . . /4/1/1 with the tile numbered 1 shown by horizontal hatched pattern in quadtree 360 of FIG. 4E, neighboring tiles are generated as follows: Neighbor to the left is generated per folder path . . . /3/2. Neighbor to the top is generated per folder path . . . /2/3. The neighbor to the right and below is the parent tile (. . . /4/1) , which was already generated during the generation process above. These neighbors are shown by diagonal hatched patterns in FIG. 4E.

As a part of the tile generation process, height/elevation data is incorporated into the tiles i.e. geometry files 120. This is accomplished by consulting an elevation grid or elevation data 116 shown in FIG. 2. Alternatively, or in addition, a mapping module (not shown) maintaining the heights of the vertices in the terrain may also be consulted. Furthermore, the types of the tiles are also incorporated into or stored along geometry files 120. In other words, surface vector data 118 of FIG. 2 is used to establish the type or class of the terrain represented by the tile e.g. earth, water, grass, trees, among others.

For determining the type of a tile, if a given point of the tile lies within a vector-defined shape, it is assigned a corresponding surface type, and if it lies outside of all such shapes, it is assigned type based on elevation data. The type and height information/metadata are also stored along geometry files 120 representing respective tiles and stored in respective folders of folder hierarchy 106. In a preferred embodiment, elevation data 116 is represented by a digital elevation model (DEM).

### Texture Generation

Next, system 100 invokes its texture generation module 122 to generate the textures of the various tiles whose geometry was generated by tile generation module 114 above. Module 122 accomplishes this by generating texture files 124 respective to each tile generated above. Each such texture file 124 is also deposited into the folder respective to the tile, along with the geometry file 120 also present therein per above. Texture generation is shown by step 208 in flowchart 200 and itself comprises of several sub-steps or steps 208A-E as detailed further below. There is one-to-one correspondence between nodes of quadtree 102, folders of folder hierarchy 106, tiles being generated, geometry files 120, texture files 124, texture coordinate mapping files 128 and 3D model files 129.

Texture generation module 122 first makes a copy of the source database SrcDB 109 as destination database DstDB 11. This is shown by step 208A. Preferably, SrcDB 109 and DstDB 111 reside in database 108 shown in FIG. 2. Module 122 then creates preliminary texture files that are then updated with texture data per below explanation. These texture files are preferably in DirectDraw Surface (DDS) file format and are also stored in DstDB/file 111. Texture generation module 122 next converts input raster data in SrcDB file 109 (and now in DstDB file 111) into Tagged Image File Format (TIFF). Preferably, it converts the source raster data stored in SrcDB to Geographic TIFF (GeoTIFF) format. Module 122 further slices the raster data into smaller pieces and scales it. It thus produces prepared raster data for the generated tiles, preferably in GeoTIFF format. This is shown by step 208B. Besides GeoTIFF, any other self-describing raster data formats including embedded metadata are conceivable. These include Network Common Data Form (NetCDF), Hierarchical Data Format (HDF5), and ERDAS IMG format, among others.

Next, texture generation module 122 creates an intermediate image or simply an intermediate file for each tile and places it in its respective folder. This is accomplished by scaling from the maximum-level intermediate file present in the texture path of the tile being generated. A texture path for a tile is the path through the quadtree that is traversed for a given tile. For example, texture path for horizontally hatched tile/node 1 in quadtree 360 of FIG. 4E is 4/4/1/1. Thus, the maximum-level intermediate file for that tile would be the intermediate file with the maximum resolution amongst folders along texture path 4/4/1/1.

This step of the creation of intermediate files by texture generation module 122 is shown by step/sub-step 208C. In the preferred embodiment, intermediate files of step 208C described above are in Joint Photographic Experts Group (JPEG or JPG) format. As a next step 208D, texture generation module 122 pastes or incorporates the raster data from prepared raster data (files) generated above in step 208B into intermediate files generated by step 208C. It does so by incorporating raster information from prepared raster data files, preferably in GeoTIFF format into only the intersecting portions of the intermediate files, preferably in JPG format.

Explained further, texture generation module 122 spatially compares raster data in prepared raster data files (in GeoTIFF format) against tiled JPG images, and for each JPG tile that overlaps the GeoTIFF, the overlapping portion of the raster is written into that tile. This preferably involves clipping and aligning the GeoTIFF data to the tile boundaries and distributing preferably higher-resolution TIFF data across all intersecting JPG files. As a result of the above process, texture generation module 122 generates texture files 124, preferably in DDS format, from the above intermediate files, preferably in JPG format. This is shown by step 208E. The texture files 124 are also incorporated into DstDB 111 stored in database 108.

Other formats besides JPEG/JPG for the intermediate files are conceivable. These include Portable Network Graphics (PNG), Bitmap (BMP) format, among others. Other formats besides DDS for texture files 124 are also conceivable. Among others, these include PNG, TIFF, WebP, and Khronos Texture (KTX) formats, each capable of storing texture data for mapping onto geometry.

At this stage, texture coordinate mappings or UV mappings are calculated/computed and applied to respective tiles. This task shown by step 210 in flowchart 200 is performed by texture coordinate mapping module 126 of FIG. 2. Each such UV mapping that maps a given tile to its respective texture, and more specifically to its geometry file 120, is stored in a texture coordinate or UV mapping file 128. In this way, the textures for the tiles contained in texture files 124 are applied to the tiles whose geometry is contained in files 120. As noted above, there is one texture coordinate/UV mapping 128 for each tile i.e. its geometry file 120, and that mapping maps the tile i.e. its geometry file 120 to its respective texture file 124.

Consequently, texture coordinate mapping module 126 stores texture coordinate or UV mappings files 128 in DstDB 111 along with the textures as texture files 124 and the tiles as geometry files 120. This means that tile geometry file 120, texture file 124 and UV Mapping file 128 for each tile is stored in their respective folder in folder hierarchy 106. Per above, folder hierarchy 106 containing the above-mentioned files is now logically stored in DstDB file 111 stored in database 108.

As shown by step 212, texture coordinate mapping module 128 also produces 3D Model files 129 containing/packaging the geometry of each tile with UV coordinates embedded. Preferably, 3D Model files are in Filmbox (FBX) format. In other words, .FBX files store the geometry (mesh) of the tiles with UV coordinates embedded per vertex and with references to texture files 124. Other formats for 3D model files 129 are conceivable. Examples include Object (OBJ), glTF (GL Transmission Format), and COLLADA (DAE), among others, each capable of storing geometry and associated data for respective tiles. Regardless, the self-contained 3D model files 129 are now ready for rendering.

For this purpose, and as shown by step 214 in flowchart 200, a rendering engine 130 of FIG. 2 is used to render 3D model files 129 that are preferably in FBX format. In other words, rendering engine 130 takes as input above FBX files 129, texture files 124 and renders or generates a georeferenced synthetic environment 132 that is presented on a computer display 134 as shown in FIG. 2. In the manner described above, the present invention performs geospatial data processing and more specifically virtual tessellation processing. Explained further, the tile-based terrain geometry preferably in FBX format with associated DDS textures is processed by rendering engine 130 and converted into a compatible virtualized geometry that supports virtual tessellation.

In the preferred embodiment, rendering engine 130 is the Nanite® platform of Unreal Engine® from Epic Game®. The present design processes the tiled meshes and textures to generate Unreal Engine-native assets optimized for adaptive, high-detail rendering. The output is a tiled database of the 3D environment in Unreal's format, organized according to the tile hierarchy and configured for virtual tessellation-based rendering. As noted above, any other rendering system/engine/technology besides Unreal Engine's Nanite platform may be utilized for this purpose.

In other words, the present approach can be applied to any other software image generators that support virtual tessellation. Examples of such suitable rendering systems supporting virtualized geometry and/or virtual tessellation include but are not limited to Unity® High Definition Render Pipeline (HDRP), NVIDIA® Omniverse™, and other custom GPU-based virtualized geometry engines.

Finally, per step 216 of flowchart 200, a binarized spatial database file 138 containing geometry files 120, texture files 124 and UV mapping files 128 stored in respective folders in folder hierarchy 106 is produced. This task is performed by packaging module 136. Spatial database .sdb file is also preferably stored in database 108 as shown. Packaging module 136 thus produces a complete database that compiles textures, tile geometry, and UV-link data into a single spatial database . sdb file. The compilation includes establishing hierarchical relationships between tiles, including links to child levels and neighboring tiles. The output is a consolidated. sdb database encoding the tiled environment and its connectivity. The above . sdb file containing spatial data is also preferably stored in database 108 as shown.

To summarize, the present technology provides an innovative approach for generating georeferenced 3D information of terrain surface in a synthetic environment. The instant approach automatically generates a file structure in a binarized database .sdb file based on input data in the form of spatial data (raster and vector). As an intermediate stage of earth generation, the present technology enables virtual tessellation of terrain data which makes it possible to significantly reduce the number of levels in comparison with the classical approaches of terrain generation in a synthetic environment.

### Definitions of Terms

The data formats recognized and used in the present technology:
1. GeoTIFF—format extension for storing georeference and geocoding information in a TIFF (Tagged Image File Format) compliant raster file by tying a raster image to a known model space or map projection. A GeoTIFF file inherits the file structure as described in the corresponding portion of the TIFF specifications. The GeoTIFF format uses a defined set of TIFF tags to describe cartographic information associated with TIFF imagery that originates from satellite imaging systems, scanned aerial photography, scanned maps, digital elevation models (DEM), or as a result of geographic analyses.
2. DEM—A Digital Elevation Model (DEM) is a representation of the bare ground (bare earth) topographic surface of the Earth excluding trees, buildings, and any other surface objects.
3. SHP—the shapefile format is a geospatial vector data format for geographic information system software. Shapefiles can represent point, line, or area features. Each feature in a shapefile represents a single geographic feature and its attributes.
4. KML—Keyhole Markup Language is an XML notation for expressing geographic annotation and visualization within two-dimensional maps and three-dimensional Earth browsers.
5. FBX—Filmbox format is an interchange file format for interactive 3D applications for exchanging digital assets among various graphics software applications.
6. PNG—Portable Network Graphics is a raster-graphics file format. PNG format supports palette-based images (with palettes of 24-bit RGB or 32-bit RGBA colors), grayscale images (with or without an alpha channel for transparency), and full-color non-palette-based RGB or RGBA images.
7. JPEG—Joint Photographic Experts Group is a raster-graphics file format .jpg. The degree of compression can be adjusted, allowing a selectable tradeoff between storage size and image quality.
8. DDS—the DirectDraw Surface container file format (uses the filename extension DDS), is a Microsoft format for storing compressed data, which can be decompressed in hardware by GPUS.
9. EXE—for Microsoft Windows, OS/2, and DOS, .exe is the filename extension that denotes a file as being executable—a computer program-containing an entry point.
10. Virtual Tessellation (or Tessellation)—in computer graphics, tessellation is the dividing of datasets of polygons (sometimes called vertex sets) presenting objects in a scene into suitable structures for rendering. Especially for real-time rendering, data is tessellated into triangles, for example in OpenGL 4.0 and Direct 3D 11.

It will be understood by those skilled in the art that various subsystems, modules or components of system/platform 100 of FIG. 2 may be centralized/integrated together or be distributed.

In view of the above teachings, a person skilled in the art will recognize that the methods of present invention can be embodied in many different ways in addition to those described without departing from the principles of the invention. Therefore, the scope of the invention should be judged in view of the appended claims and their legal equivalents.

What is claimed is:

1. A computer-implemented method comprising the steps of:
(a) creating a quadtree in a non-transitory storage medium of a computer system, said quadtree comprising a plurality of nodes representing respective tiles of a terrain;
(b) based on a scope and a level of data rendering selected by a user and further based on a source resolution, generating and storing a folder hierarchy in a destination database, said folder hierarchy comprising a plurality of folders corresponding to said plurality of nodes of said quadtree;
(c) generating respective geometry files of said respective tiles in said plurality of folders based on elevation data and surface vector data of said respective tiles;
(d) converting source raster data to a first image file format and slicing and scaling it to obtain prepared raster data;
(e) creating respective intermediate files in a second image file format in said plurality of folders stored in said destination database, wherein each of said respective intermediate files resides along its texture path in said folder hierarchy, and wherein said each of said respective intermediate files is scaled from a maximum-level intermediate file amongst raid respective intermediate files, said maximum-level intermediate file residing at the maximum level of said texture path;
(f) incorporating said prepared raster data into said respective intermediate files;
(g) generating respective texture files for said respective tiles based on said respective intermediate files and storing said respective texture files in said plurality of folders;
(h) computing respective texture coordinate mappings for mapping said respective tiles to said respective texture files, and storing said respective texture coordinate mappings as respective texture coordinate mapping files in said plurality of folders stored in said destination database;
(i) generating respective three-dimensional (3D) model files based on said respective geometry files, said respective texture files and said respective texture coordinate mapping files; and
(j) rendering a synthetic environment sliced into said respective tiles based on said respective 3D model files.

2. The method of claim 1, further prioritizing said source raster data over said elevation data for selecting said source resolution.

3. The method of claim 1, further generating a binarized spatial database file comprising said geometry files, said texture files and said texture coordinate mapping files.

4. The method of claim 1, further storing respective types of said respective tiles along with said respective

3. geometry files in said plurality of folders stored in said destination database.

5. The method of claim 1, wherein said first image file format is Geographic Tagged Image File Format (GeoTIFF).

6. The method of claim 1, wherein said second image file format is a Joint Photographic Experts Group (JPEG) file format.

7. The method of claim 1, wherein said respective texture files are in DirectDraw Surface (DDS) file format.

8. The method of claim 1, wherein said 3D model files are in Filmbox (FBX) format.

9. The method of claim 1, wherein said rendering is performed by Nanite® from Epic Game®.

10. The method of claim 1, wherein said source raster data is stored in a source database and said prepared raster data is stored in said destination database.

11. A geospatial data processing system executing computer-readable instructions stored in a non-transitory storage medium and at least one microprocessor coupled to said non-transitory storage medium for executing said computer-readable instructions, said computer-readable instructions causing said at least one microprocessor to:
(a) create a quadtree in said non-transitory storage medium, said quadtree comprising a plurality of nodes representing respective tiles of a terrain;
(b) based on a scope and a level of data rendering selected by a user and further based on a source resolution, generate and store a folder hierarchy in a destination database, said folder hierarchy comprising a plurality of folders corresponding to said plurality of nodes of said quadtree;
(c) generate by a tile generation module, respective geometry files of said respective tiles in said plurality of folders based on elevation data and surface vector data of said respective tiles;
(d) deploy a texture generation module to convert source raster data to a first image file format and to slice it and scale it to obtain prepared raster data;
(e) create by said texture generation module, respective intermediate files in a second image file format in said plurality of folders stored in said destination database, wherein each of said respective intermediate files resides along its texture path in said folder hierarchy, and wherein said each of said respective intermediate files is scaled from a maximum-level intermediate file amongst raid respective intermediate files, said maximum-level intermediate file residing at the maximum level of said texture path;
(f) incorporate by said texture generation module, said prepared raster data into said respective intermediate files;
(g) deploy said texture generation module to generate respective texture files for said respective tiles based on said respective intermediate files and to store said respective texture files in said plurality of folders;
(h) deploy a texture coordinate mapping module to compute respective texture coordinate mappings for mapping said respective tiles to said respective texture files, and to store said respective texture coordinate mappings as respective texture coordinate mapping files in said plurality of folders stored in said destination database;
(i) generate by said texture coordinate mapping module, respective three-dimensional (3D) model files based on said respective geometry files, said respective texture files and said respective texture coordinate mapping files; and
(j) use a rendering engine to render based on said respective 3D model files, a synthetic environment sliced into said respective tiles.

12. The geospatial data processing system of claim 11, wherein said source raster data is prioritized over said elevation data for selecting said source resolution.

13. The geospatial data processing system of claim 11, wherein said at least one microprocessor further generates a binarized spatial database file comprising said geometry files, said texture files and said texture coordinate mapping files.

14. The geospatial data processing system of claim 11, wherein said at least one microprocessor further stores respective types of said respective tiles along with said respective geometry files in said plurality of folders stored in said destination database.

15. The geospatial data processing system of claim 11, wherein said first image file format is Geographic Tagged Image File Format (GeoTIFF).

16. The geospatial data processing system of claim 11, wherein said second image file format is a Joint Photographic Experts Group (JPEG) file format.

17. The geospatial data processing system of claim 11, wherein said respective texture files are in DirectDraw Surface (DDS) file format.

18. The geospatial data processing system of claim 11, wherein said 3D model files are in Filmbox (FBX) format.

19. The geospatial data processing system of claim 11, wherein said rendering engine is Nanite® from Epic Game®.

20. The geospatial data processing system of claim 11, wherein said source raster data is stored in a source database and said prepared raster data is stored in said destination database.
